(19) United States
(12) Patent Application Publication
(10) Pub. No.: US 2017/0201358 A1
(43) Pub. Date: Jul. 13, 2017

(54) ANTENNA MULTIPLEXING METHOD AND ELECTRONIC DEVICE

(71) Applicants: LE HOLDINGS (BEIJING) CO., LTD., Beijing (CN); LEMOBILE INFORMATION TECHNOLOGY (BEIJING) CO., LTD, Beijing (CN)

(72) Inventors: Xiuqiang LI, Beijing (CN); Xu WANG, Beijing (CN); Kang LU, Beijing (CN)

(21) Appl. No.: 15/242,495

(22) Filed: Aug. 20, 2016

Related U.S. Application Data
(63) Continuation of application No. PCT/CN2016/088831, filed on Jul. 6, 2016.

(30) Foreign Application Priority Data
Jan. 8, 2016 (CN) 2016100119429

(51) Int. Cl. H04L 5/00; H04M 3/42; H04B 17/318; H04W 74/00; H04L 5/14

(52) U.S. Cl. CPC H04L 5/0042; H04W 74/006; H04L 5/14; H04B 17/318; H04M 3/42178; H04W 84/12

(57) ABSTRACT

Disclosed are an antenna multiplexing method and an electronic device. Wherein, the mobile terminal includes a WLAN antenna, a WLAN communication module and an antenna multiplexing module. The WLAN communication module is connected with the WLAN antenna, and supports a multi-channel MIMO function. The method comprises: querying other mobile terminals which can share a WLAN antenna in a WLAN where the mobile terminal is located; selecting at least one mobile terminal from the other mobile terminals; and multiplexing a WLAN antenna of the at least one mobile terminal to acquire downlink data.

### CROSS REFERENCE TO RELATED APPLICATIONS

The present application is a continuation of PCT application which has an application number of PCT/CN2016/088831 and was filed on Jul. 6, 2016. This application claims the priority to Chinese Patent Application No. 201610011942.9, entitled “MOBILE TERMINAL AND ANTENNA MULTIPLEXING METHOD” and filed with the Chinese State Intellectual Property Office on Jan. 8, 2016, which is incorporated herein by reference in its entirety.

### TECHNICAL FIELD

The disclosure relates to the field of communication technology, and particularly to an antenna multiplexing method and an electronic device.

### BACKGROUND

In the Multiple Input and Multiple Output (MIMO) technology, a multi-path antenna is used to transmit and receive simultaneously, thereby improving capacity and a frequency spectrum utilization ratio of wireless communication exponentially without increasing the bandwidth. The MIMO technology has been widely used for the wireless communication technology, for example, a standard corresponding to the MIMO technology is set in a standard such as 802.11n, 802.16-2204 and 802.16e in Wireless Local Area Network (WLAN) and the 3GPP standard in the 3G cellular network, the MIMO technology has been widely used in an application in the WLAN.

In a mobile terminal, multiple antennas related to the communication technology are adopted. For example, not only a GPS antenna for realizing a voice function, but also a Bluetooth antenna for realizing a Bluetooth function and/or a WiFi antenna for realizing a WiFi function are included in the mobile terminal. Specifically, in the cellular (cellular network) technology, the GPS antenna includes a primary antenna and a diversity antenna, so that in a case that performance of a certain antenna deteriorates rapidly due to an operation such as a hand grasp operation of a user, it can be switched into another antenna. Also, the primary antenna and the diversity antenna can be disposed at different locations of the mobile terminal.

In the mobile terminal described above, a built-in MIMO control chip is disposed increasingly, to connect the multiple antennas with each other and realize transmitting and receiving in the multiple channels. However, due to a limit for an internal space of the mobile terminal, it is unable to set multiple separate antennas for the WLAN in the mobile terminal, in this case, a function of the MIMO technology in the WLAN is limited.

In the conventional technology, since that the WLAN and the cellular technology are generally used in the mobile terminal, a GPS diversity antenna in the cellular technology is multiplexed as a WLAN MIMO antenna, that is, the GPS diversity antenna is multiplexed in both the WLAN and the cellular.

However, the GPS diversity antenna is designed mainly for the cellular network, the efficiency of the GPS diversity antenna is not high in a case that the GPS diversity antenna is applied into the WLAN MIMO, therefore, a radiation efficiency and a data transmission speed of the WLAN MIMO antenna are affected.

Therefore, it is desirable to develop a new antenna multiplexing technology for the mobile terminal, to take full advantage of the MIMO technology.

### SUMMARY

In view of this, an objective of the present disclosure is to solve a technical solution that a mobile terminal realizes a MIMO function by multiplexing an antenna of multiple mobile terminals connected with each other in the WLAN.

An antenna multiplexing method for a mobile terminal is provided according to one aspect of the present disclosure, the mobile terminal may include a WLAN antenna, a WLAN communication module and an antenna multiplexing module. The WLAN communication module is connected with the WLAN antenna, and supports a multi-channel MIMO function.

The antenna multiplexing method may include: querying other mobile terminals, which can share a WLAN antenna, in a WLAN where the mobile terminal is located; selecting at least one mobile terminal from the other mobile terminals; and multiplexing a WLAN antenna of the at least one mobile terminal to acquire downlink data.

Optionally, the mobile terminal and the other mobile terminals support a sharing agreement and support the multi-channel MIMO function.

Optionally, whether the other mobile terminals support the sharing agreement and support the multi-channel MIMO function is determined based on built-in hardware information or configuration information of the mobile terminal and the other mobile terminals.

Optionally, the querying other mobile terminals which can share a WLAN antenna in a WLAN where the mobile terminal is located may include querying strength of signals of the other mobile terminals, and the selecting at least one mobile terminal from the other mobile terminals may include selecting at least one mobile terminal from the other mobile terminals based on the strength of the signals.

Optionally, the multiplexing a WLAN antenna of the at least one mobile terminal to acquire downlink data may include allocating different channels to the mobile terminal and the at least one mobile terminal; retrieving downloaded data from the at least one mobile terminal; and synthesizing downlink data received by different mobile terminals via the different channels.

Optionally, a channel allocation function of the at least one mobile terminal is disabled during the step of retrieving the downloaded data.

Optionally, a same channel as the at least one mobile terminal is allocated to the mobile terminal during the step of retrieving the downloaded data.

Optionally, the at least one mobile terminal is selected from the other mobile terminals under the authority of the other mobile terminals in the step of selecting the at least one mobile terminal.

An electronic device is provided according to another aspect of the present disclosure, comprising: at least one processor; and a memory communicably connected with the at least one processor for storing instructions executable by the at least one processor, wherein execution of the instructions by the at least one processor causes the at least one processor to: query other mobile terminals which can share a WLAN antenna in a WLAN where a mobile terminal is located; select at least one mobile terminal from the other mobile terminals; and multiplex a WLAN antenna of the at least one mobile terminal to acquire downlink data.

Optionally, the execution of the instructions by the at least one processor causes the at least one processor further to: encode an uplink data stream; and decode a downlink data stream.

Optionally, the mobile terminal and the other mobile terminals support a sharing agreement and support the multi-channel MIMO function.

Optionally, the sharing agreement is built-in hardware information or configuration information of the mobile terminal and the other mobile terminals.

Optionally, an application in the mobile terminal and the other mobile terminals provides the configuration information.

Optionally, the querying process comprises querying strength of signals of the other mobile terminals, and the selecting process comprises selecting the at least one mobile terminal from the other mobile terminals based on the strength of the signals.

Optionally, the multiplexing process comprises: querying the other mobile terminals which can share a WLAN antenna; selecting at least one mobile terminal and allocate different channels to the mobile terminal and the at least one mobile terminal; retrieving downloaded data from the at least one mobile terminal; and synthesizing downlink data received by different mobile terminals via the different channels.

Optionally, the retrieving downloaded data from the at least one mobile terminal further comprises disabling a channel allocation function of the at least one mobile terminal during retrieving the downloaded data.

Optionally, the retrieving downloaded data from the at least one mobile terminal further comprises allocating a same channel as the at least one mobile terminal to the mobile terminal during retrieving the downloaded data.

Optionally, the selecting process comprises: under authority of the other mobile terminals, selecting from the other mobile terminals as the at least one mobile terminal and allocate the channel to the at least one mobile terminal.

Optionally, the WLAN antenna is a WiFi antenna.

In the mobile terminal according to the embodiments of the application described above, at least one mobile terminal is selected from multiple other mobile terminals in the WLAN, thereby the multiple mobile terminals downloads cooperatively. When downloading the data, different channels are allocated to different mobile terminals, and data acquired by the different mobile terminals are synthesized into a complete data stream, so that a mobile terminal can multiplex a WLAN antenna of the other mobile terminals, thereby improving a download speed and improving user experience in a wireless communication system.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic block diagram of a mobile terminal and a wireless communication system as a comparative example according to an embodiment of the present disclosure;

FIG. 2 is a schematic block diagram of a mobile terminal and a wireless communication system based on MIMO technology according to an embodiment of the present disclosure;

FIG. 3 is a flow diagram of an antenna multiplexing method according to an embodiment of the present disclosure;

FIG. 4 illustrates a hardware structure of a electronic device performing an antenna multiplexing method according to an embodiment of the present disclosure.

### DETAILED DESCRIPTION

Preferred embodiments of the present disclosure are described in detail below in conjunction with the drawings, however, the present disclosure is not limited thereto. The present disclosure contains any substitutions, changes, equivalent methods or solutions made within the sprit and scope of the present disclosure.

In order to make the public fully understand the present disclosure, specific details are described in detail in the preferred embodiments of the present disclosure below, those skilled in the art can complete understand the present disclosure without the description for the specific details.

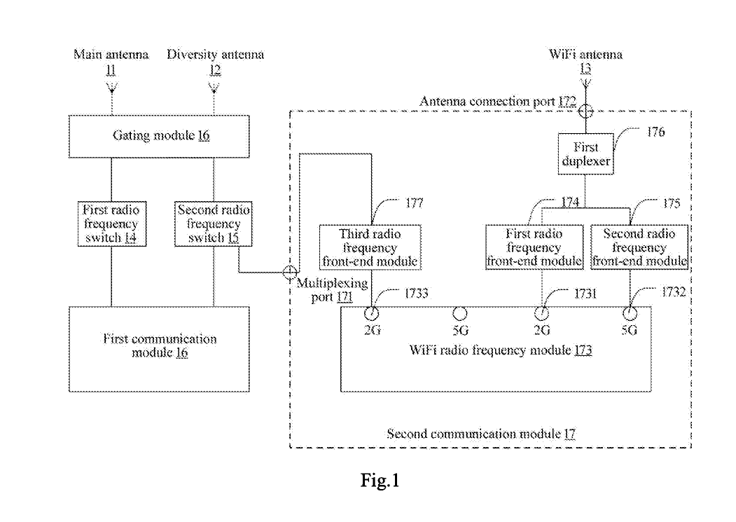

FIG. 1 is a schematic block diagram of a mobile terminal and a wireless communication system as a comparative example according to an embodiment of the present disclosure. The wireless communication system is for example a part of a cell phone, and includes a primary antenna 11, a diversity antenna 12, a WiFi antenna 13, a first radio frequency switch 14, a second radio frequency switch 15, a first communication module 16, a second communication module 17 and a gating module 18.

Specifically, the first radio frequency switch 14 is connected with the first communication module 16. The second radio frequency switch 15 is connected with the first communication module 16 and the second communication module 17, respectively. The second communication module 17 includes a multiplexing port 171 and an antenna connection port 172, and is connected with the second radio frequency switch 15 via the multiplexing port 171, and is connected with the WiFi antenna 13 via the antenna connection port 172. The gating module 18 is connected with the primary antenna 11, the diversity antenna 12, the first radio frequency switch 14 and the second radio frequency switch 15, respectively, and is configured to connect the primary antenna 11 with the second radio frequency switch 15 in a first operating mode, and connect the diversity antenna 12 with the second radio frequency switch 15 in a second operating mode.

In the comparative example, the first communication module 16 may be a mobile communication module of the electrode device, and can realize communication in multiple frequency bands. The second communication module 17 may be a WiFi communication module of the electronic device, and can realize communication in multiple frequency bands. In the first operating mode in which the WiFi communication module operates, the second radio frequency switch 15 is configured to connect the primary antenna 11 with the second communication module 17, so that the WiFi antenna and the primary antenna forms a MIMO antenna, to raise a wire speed. In the second operating mode in which the mobile communication module operates, the first radio switch 14 and the second radio frequency switch 15 are configured to connect the primary antenna, the diversity antenna with the first communication module 16, to realize mobile communication.

The second communication module 17 includes a WiFi radio frequency module 173, a first radio frequency front-end module 174, a second radio frequency front-end module 175 and a first duplexer 176.

In the comparative example, the WiFi radio frequency module 173 includes a first frequency band antenna connection port 1731 and a second frequency band antenna connection port 1732. The first frequency band antenna connection port 1731 is configured to transmit and receive a radio frequency signal in a frequency band of 2.4 G. The second frequency band antenna connection port 1732 is configured to transmit and receive a radio frequency signal in a frequency band of 5 G.

The first radio frequency front-end module 174 is connected with the first frequency band antenna connection port 1731 of the WiFi radio frequency module 173. The second radio frequency front-end module 175 is connected with the second frequency band antenna connection port 1732 of the WiFi radio frequency module 173. The first duplexer 176 is connected with the first radio frequency front-end module 174 and the second radio frequency front-end module 175, respectively, and is configured to synthesize a first frequency band signal and a second frequency band signal of the WiFi radio frequency module 173 and transmit via the WiFi antenna 13, or decompose a signal received via the WiFi antenna 13 into a first frequency band signal and a second frequency band signal and transmit to the WiFi radio frequency module 173 via the first radio frequency front-end module 174 and the second radio-frequency front-end module 175.

In the comparative example, the WiFi radio frequency module 173 may further include a first frequency band multiplexing port 1733. The first frequency band multiplexing port 1733 is configured to transmit and receive a radio frequency signal in a frequency band of 2.4 G.

The second communication module 17 may further include a third radio frequency front-end module 177, the third radio frequency front-end module 177 is connected to the WiFi radio frequency module 173 via the first frequency band multiplexing port 1733.

In the comparative example, the gating module 8 consists of for example two double-pole double-throw switches.

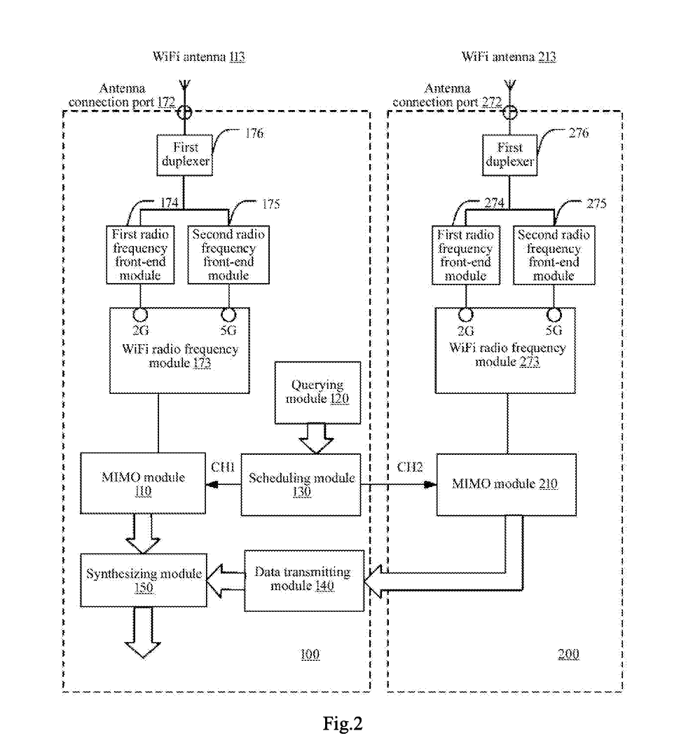

FIG. 2 is a schematic block diagram of a mobile terminal and a wireless communication system according to an embodiment of the present disclosure. The wireless communication system includes multiple mobile terminals within a same WLAN.

In FIG. 2, two cell phones are taken as an example, each of a first cell phone 100 and a second cell phone 200 includes a wireless communication module, and supports a MIMO function. In the embodiment, the first cell phone 100 is a main device for requesting downloading data, and the second cell phone 200 is a slave device for providing an antenna to be multiplexed. However, it can be understood that the WLAN may include a great number of cell phones more than two cell phones, and each cell phone can be served as any one of the main device and the slave device.

The first cell phone 100 includes a WiFi antenna 113 and a communication module connected to the WiFi antenna 113. The communication module includes an MIMO module 110, a WiFi radio frequency module 173, a first radio frequency front-end module 174, a second radio frequency front-end module 175 and a first duplexer 176.

In the embodiment, the WiFi radio frequency module 173 includes a first frequency band antenna connection port and a second frequency band antenna connection port. The first frequency band antenna connection port is configured to transmit and receive a radio frequency signal in a frequency band of 2.4 G and the second frequency band antenna connection port is configured to transmit and receive a radio frequency signal in a frequency band of 5 G.

The first radio frequency front-end module 174 is connected with the first frequency band antenna connection port of the WiFi radio frequency module 173, the second radio frequency front-end module 175 is connected with the second frequency band antenna connection port of the WiFi radio frequency module 173. The first duplexer 176 is connected to the first radio frequency front-end module 174 and the second radio frequency front-end module 175, respectively, and is configured to synthesize a first frequency band signal and a second frequency band signal of the WiFi radio frequency module 173 and transmit via the WiFi antenna 113, or decompose a signal received via the WiFi antenna 113 into a first frequency band signal and a second frequency band signal and transmit to the WiFi radio frequency module 173 via the first radio frequency front-end module 174 and a second radio frequency front-end module 175. The MIMO module 110 is connected to the WiFi radio frequency module 173. The MIMO module 110 includes an encoding module and a decoding module, the encoding module is configured to encode a data stream in an assigned channel in an uplink mode, and the decoding module is configured to decode a data stream in an assigned channel in a downlink mode.

Furthermore, different from a communication mode of the existing cell phone, the first cell phone may further include an antenna multiplexing module. The antenna multiplexing module is configured to query other cell phones, which can share a WiFi antenna, in a WLAN where the first cell phone is located, and select at least one cell phone from the other cell phones, and multiplex the WiFi antenna of the at least one cell phone to acquire downlink data.

As shown in FIG. 2, the antenna multiplexing module includes a querying module 120, a scheduling module 130, a data transmitting module 140 and a synthesizing module 150. The querying module 120 is configured to query other cell phones which can share a WiFi antenna. The scheduling module 130 is configured to select at least one cell phone and allocate different channels to the cell phone and the at least one cell phone. The data transmitting module 140 is configured to retrieve downloaded data from the at least one cell phone. The synthesizing module 150 is configured to synthesize downlink data received by different cell phones via different channels.

In the embodiment, the scheduling module 130 of the first cell phone 100 allocates a channel CH1 to the first cell phone 100.

The second cell phone 200 includes a WiFi antenna 213 and a communication module connected to the WiFi antenna 213. The communication module includes an MIMO module 210, a WiFi radio frequency module 273, a first radio frequency front-end module 274, a second radio frequency front-end module 275 and a first duplexer 276.

In the embodiment, the WiFi radio frequency module 273 includes a first frequency band antenna connection port and a second frequency band antenna connection port. The first frequency band antenna connection port is configured to transmit and receive a radio frequency signal in a frequency band of 2.4 G and the second frequency band antenna connection port is configured to transmit and receive a radio frequency signal in a frequency band of 5 G.

The first radio frequency front-end module 274 is connected to the first frequency band antenna connection port of the WiFi radio frequency module 273, the second radio frequency front-end module 275 is connected with the second frequency band antenna connection port of the WiFi radio frequency module 273. The first duplexer 276 is connected with the first radio frequency front-end module 274 and the second radio frequency front-end module 275, respectively, and is configured to synthesize a first frequency band signal and a second frequency band signal of the WiFi radio frequency module 273 and transmit via the WiFi antenna 213, or decompose a signal received via the WiFi antenna 213 into a first frequency band signal and a second frequency band signal and transmit to the WiFi radio frequency module 273 via the first radio frequency front-end module 274 and the second radio frequency front-end module 275. The MIMO module 210 is connected with the WiFi radio frequency module 273, and is configured to encode a data stream in an uplink mode, and decode a data stream in a downlink mode.

In the embodiment, the scheduling module 130 of the first cell phone 100 allocates a channel CH2 to the second cell phone 200.

In the wireless communication system according to the embodiment of the present disclosure, both the first cell phone and the second cell phone support the sharing arrangement and support a multi-channel MIMO function. The sharing arrangement is built-in hardware information and configuration information within the first cell phone and the second cell phone. For example, the scheduling module of the first cell phone can assign different channels CH1 and CH2 for MIMO modules in the first cell phone and the second cell phone when the first cell phone downloads data, respectively. Therefore, the first cell phone may multiplex the antenna of the second cell phone, and acquires a part of a data stream by using the second cell phone, and synthesize into a complete data stream, thereby downloading the data. In the wireless communication system, a download speed can be raised, and the user experience can be improved.

The querying module 120, the scheduling module 130, the data transmitting module 140 and the synthesizing module 150 in the first cell phone 100 can be implemented with a hardware circuit, or may also be implemented with a dedicated application for example an Android package. Before synthesizing the data stream, the second cell phone transmits the data stream to the first cell phone, so that the first cell phone can retrieve the downloaded data.

In an optional embodiment, the scheduling module of the first cell phone disables a channel allocation function of the second cell phone and allocates a same channel with the second cell phone to the first cell phone during retrieving the data. Therefore, the first cell phone can realize data synthesis of multiple channels by using a hardware function of the MIMO module 210.

In an optional embodiment, the scheduling module 130 of the first cell phone is configured to select the second cell phone as a cell phone for multiplexing the WiFi antenna under authority of the second cell phone, and allocate a channel to the second cell phone, thereby further improving security.

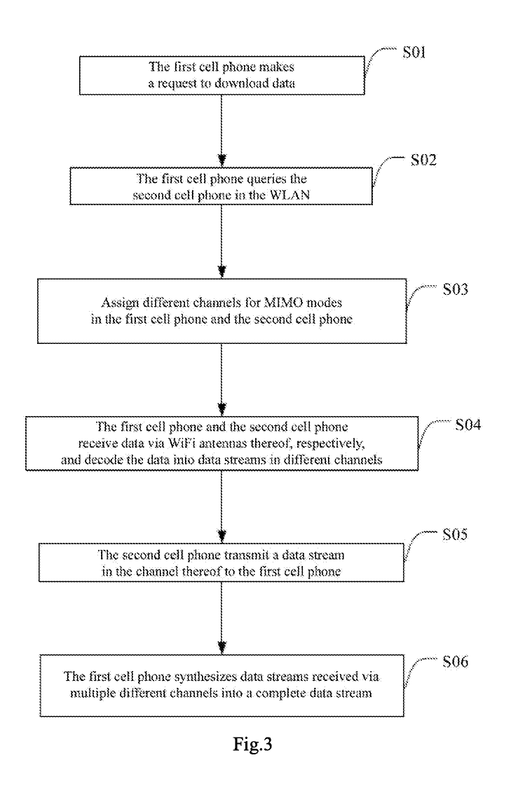

FIG. 3 is a flow diagram of an antenna multiplexing method according to an embodiment of the present disclosure. In a wireless communication system, a first cell phone 100 and a second cell phone 200 are connected within a WLAN.

In step S01, the first cell phone 100 makes a request to download data.

In step S02, a querying module 120 of the first cell phone 100 queries the second cell phone in the WLAN. Preferably, subsequent channel allocation is performed in a case that the second cell phone 200 authorizes sharing a WiFi antenna, to avoid a security problem since that the WiFi antenna is shared without authorization.

In step S03, a scheduling module 130 of the first cell phone 100 assigns different channels CH1 and CH2 for MIMO modes in the first cell phone 100 and the second cell phone 200, respectively.

In step S04, the first cell phone 100 and the second cell phone 200 receive data via WiFi antennas thereof, respectively, and decode the data into data streams in different channels.

In step S05, the data transmitting module 140 of the first cell phone 100 transmits a data stream downloaded by the second cell phone 200 via the channel CH2 to the first cell phone 100. In the step, optionally, the scheduling module 130 of the first cell phone 100 disables a channel allocation function, and reassigns the channel of the first cell phone 100 to be the CH2, so that the data stream of the second cell phone 200 can be transmitted to the first cell phone 100 via the WLAN.

In step S06, the synthesizing module 150 of the first cell phone synthesizes data streams received by the first cell phone 100 and the second cell phone 200 via multiple different channels into a complete data stream, thereby downloading the data.

In the embodiment described above, the wireless communication system including multiple cell phones is described, the first cell phone which makes a request to download data is the main device, and the second cell phone in the WLAN shares the WiFi antenna, so that the first cell phone multiplexes the antenna of the second cell phone, thereby realizing the MIMO function. However, the device in the wireless communication network is not limited to the cell phone, and may be any mobile terminal having the WiFi antenna and the MIMO module.

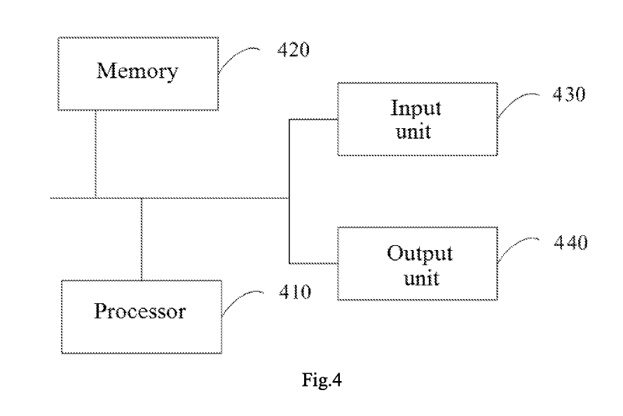

FIG. 4 is a block diagram of an electronic device performing an antenna multiplexing method according to an embodiment of the present disclosure. As shown in FIG. 4, the device includes: one or more processors 410 and memory 420. A processor 410 is showed in FIG. 4 for an example.

Device which is configured to perform the antenna multiplexing method can also include: input unit 430 and output unit 440.

Processor 410, memory 420, input unit 430 and output unit 440 can be connected by BUS or other methods, and BUS connecting is showed in FIG. 4 for an example.

Memory 420 can be used for storing non-transitory software program, non-transitory computer executable program and modules as a non-transitory computer-readable storage medium, such as corresponding program instructions/modules for the antenna multiplexing method mentioned by embodiments of the present disclosure. Processor 410 performs kinds of functions and data processing by executing non-transitory software program, instructions and modules which are stored in memory 420, thereby realizes the an antenna multiplexing method by embodiments of the present disclosure.

Memory 420 can include program storage area and data storage area, thereby the operating system and applications required by at least one function can be stored in program storage area and data created by using the device for antenna multiplexing can be stored in data storage area. Furthermore, memory 420 can include high speed Random-access memory (RAM) or non-volatile memory such as magnetic disk storage device, flash memory device or other non-volatile solid state storage devices. In some embodiments, memory 420 can include long-distance setup memories relative to processor 410, which can communicate with the device for antenna multiplexing. The examples of said networks are including but not limited to Internet, Intranet, LAN, mobile Internet and their combinations.

Input unit 430 can be used to receive inputted number, character information and key signals causing user configures and function controls of the device for antenna multiplexing. Output unit 440 can include a display screen or a display device.

The said module or modules are stored in memory 420 and perform the antenna multiplexing methods when executed by one or more processors 410.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile intemet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-19 (canceled)

20. An electronic device, comprising:
at least one processor; and
a memory communicably connected with the at least one processor for storing instructions executable by the at least one processor, wherein execution of the instructions by the at least one processor causes the at least one processor to:
query other mobile terminals which can share a WLAN antenna in a WLAN where a mobile terminal is located;
select at least one mobile terminal from the other mobile terminals; and
multiplex a WLAN antenna of the at least one mobile terminal to acquire downlink data.

21. The electronic device according to claim 20, wherein the execution of the instructions by the at least one processor causes the at least one processor further to:
encode an uplink data stream; and
decode a downlink data stream.

22. The electronic device according to claim 20, wherein the mobile terminal and the other mobile terminals support a sharing agreement and support the multi-channel MIMO function.

23. The electronic device according to claim 22, wherein the sharing agreement is built-in hardware information or configuration information of the mobile terminal and the other mobile terminals.

24. The electronic device according to claim 23, wherein an application in the mobile terminal and the other mobile terminals provides the configuration information.

25. The electronic device according to claim 22, wherein the querying process comprises querying strength of signals of the other mobile terminals, and the selecting process comprises selecting the at least one mobile terminal from the other mobile terminals based on the strength of the signals.

26. The electronic device according to claim 21, wherein the multiplexing process comprises:
querying the other mobile terminals which can share a WLAN antenna;
selecting at least one mobile terminal and allocate different channels to the mobile terminal and the at least one mobile terminal;
retrieving downloaded data from the at least one mobile terminal; and
synthesizing downlink data received by different mobile terminals via the different channels.

27. The electronic device according to claim 26, wherein the retrieving downloaded data from the at least one mobile terminal further comprises disabling a channel allocation function of the at least one mobile terminal during retrieving the downloaded data.

28. The electronic device according to claim 26, wherein the retrieving downloaded data from the at least one mobile terminal further comprises allocating a same channel as the at least one mobile terminal to the mobile terminal during retrieving the downloaded data.

29. The electronic device according to claim 26, wherein the selecting process comprises: under authority of the other mobile terminals, selecting from the other mobile terminals as the at least one mobile terminal and allocate the channel to the at least one mobile terminal.

30. The electronic device according to claim 20, wherein the WLAN antenna is a WiFi antenna.

31. An antenna multiplexing method for a mobile terminal, wherein the mobile terminal comprises a WLAN antenna, a WLAN communication module and an antenna multiplexing module, the WLAN communication module is connected with the WLAN antenna and supports a multi-channel MIMO function, the antenna multiplexing method comprises:
querying other mobile terminals which can share a WLAN antenna in a WLAN where the mobile terminal is located;
selecting at least one mobile terminal from the other mobile terminals; and
multiplexing a WLAN antenna of the at least one mobile terminal to acquire downlink data.

32. The method according to claim 31, wherein the mobile terminal and the other mobile terminals support a sharing agreement and support the multi-channel MIMO function.

33. The method according to claim 32, wherein whether the other mobile terminals support the sharing agreement and support the multi-channel MIMO function is determined based on built-in hardware information or configuration information of the mobile terminal and the other mobile terminals.

34. The method according to claim 32, wherein the querying other mobile terminals which can share a WLAN antenna in a WLAN where the mobile terminal is located comprises querying strength of signals of the other mobile terminals, and the selecting at least one mobile terminal from the other mobile terminals comprises selecting at least one mobile terminal from the other mobile terminals based on the strength of the signals.

35. The method according to claim 31, wherein the multiplexing a WLAN antenna of the at least one mobile terminal to acquire downlink data comprises:
allocating different channels to the mobile terminal and the at least one mobile terminal; and
retrieving downloaded data from the at least one mobile terminal; and
synthesizing the downlink data received by different mobile terminals via the different channels.

36. The method according to claim 35, wherein a channel allocation function of the at least one mobile terminal is disabled during the step of retrieving the downloaded data.

37. The method according to claim 35, wherein a same channel as the at least one mobile terminal is allocated to the mobile terminal during the step of retrieving the downloaded data.

38. The method according to claim 31, wherein the at least one mobile terminal is selected from the other mobile terminals under the authority of the other mobile terminals in the step of selecting the at least one mobile terminal.
